(19) United States
(12) Patent Application Publication
(10) Pub. No.: US 2024/0204324 A1
(43) Pub. Date: Jun. 20, 2024

(54) BATTERY MODULE

(71) Applicant: HONDA MOTOR CO., LTD., Tokyo (JP)

(72) Inventors: Shigeru KOYAMA, Saitama (JP); Gentaro FUJII, Saitama (JP)

(73) Assignee: HONDA MOTOR CO., LTD., Tokyo (JP)

(21) Appl. No.: 18/541,772

(22) Filed: Dec. 15, 2023

(30) Foreign Application Priority Data
Dec. 19, 2022 (JP) 2022-202294

(51) Int. Cl. H01M 50/242; H01M 50/211; H01M 50/249; H01M 50/264; H01M 50/291

(52) U.S. Cl. CPC H01M 50/242; H01M 50/211; H01M 50/249; H01M 50/264; H01M 50/291; H01M 2220/20

(57) ABSTRACT

A battery module includes laminated cells laminated in a horizontal direction, an intermediate plate provided in an intermediate portion in a lamination direction, a pair of end plates provided on both end portions of the laminated cells in the lamination direction, and a pair of restraining members facing each other in a first direction orthogonal to the lamination direction and coupled to the end plates to restrain the laminated cells. Each laminated cell includes an electrode tab extending in a second direction orthogonal to the lamination direction and the first direction. A cover plate extending in the lamination direction and covering the electrode tab is provided outward than the laminated cells in the second direction. The cover plate is coupled to the intermediate plate or the end plates. The cover plate is provided with fixing portions on both end sides in the lamination direction with respect to the intermediate plate.

### CROSS-REFERENCE TO RELATED APPLICATIONS

This application is based on and claims priority under 35 USC 119 from Japanese Patent Application No. 2022-202294 filed on Dec. 19, 2022, the entire content of which is incorporated herein by reference.

### TECHNICAL FIELD

The present disclosure relates to a battery module mounted on an electric vehicle or the like.

### BACKGROUND ART

In recent years, researches and developments have been conducted on a secondary battery which contributes to improvement in energy efficiency in order to allow more people to access affordable, reliable, sustainable and advanced energy.

A laminated cell or a square cell is known as a secondary battery. For example, JP7142063B discloses a power storage module in which laminated cells are laminated. Further, JP6184938B discloses a power storage module including square cells. When the power storage module of JP6184938B is attached to a vehicle body frame, a pair of end plates are attached to the vehicle body frame via brackets.

In the power storage module of JP7142063B, a high pressure is applied to the end plates due to cell swelling of the laminated cells. In a power storage module in which a plurality of laminated cells are laminated, when a pair of end plates are fixed to a vehicle body frame as in JP6184938B, stress concentrates on fixing portions between the end plates and the vehicle body frame due to cell swelling. Therefore, a reinforcing structure may be provided in the vicinity of the fixing portions, but the number of components increases and the structure increases in size.

### SUMMARY OF INVENTION

The present disclosure provides a battery module which is to be attached to a support member and in which concentration of stress on a fixing portion between the battery module and the support member is prevented even when a laminated cell swells.

An aspect of the present disclosure relates to a battery module to be mounted on a vehicle and fixed to a support member, the battery module including:
a plurality of laminated cells laminated in a horizontal direction;
an intermediate plate provided in an intermediate portion in a lamination direction of the plurality of laminated cells;
a pair of end plates provided on both end portions of the plurality of laminated cells in the lamination direction, and
a pair of restraining members facing each other in a first direction orthogonal to the lamination direction and coupled to the pair of end plates to restrain the plurality of laminated cells.
in which each of the laminated cells includes an electrode tab extending in a second direction orthogonal to the lamination direction and the first direction,
a cover plate extending in the lamination direction and covering the electrode tab is provided outward than the plurality of laminated cells in the second direction,
the cover plate is coupled to at least one of the intermediate plate or the pair of end plates, and
the cover plate is provided with at least a first fixing portion and a second fixing portion, which fix the battery module to the support member, on one-end side and other-end side in the lamination direction with respect to the intermediate plate.

According to the present disclosure, even when cell swelling of the laminated cell occurs, concentration of stress on the fixing portion between the battery module and the support member can be prevented.

### BRIEF DESCRIPTION OF DRAWINGS

Exemplary embodiment(s) of the present invention will be described in detail based on the following figures, wherein:

FIG. 1 is a schematic perspective view showing an internal structure of a battery pack 1 in which battery modules 10 of each embodiment of the present disclosure are mounted;

FIG. 2 is an exploded perspective view of the battery module 10 of a first embodiment of the present disclosure;

FIG. 3 is a perspective view of a laminated cell 21;

FIG. 4 is a perspective view showing a plurality of laminated cells 21 laminated in a horizontal direction and bus bars 22 connecting electrode tabs 212 of the laminated cells 21:

FIG. 5 is a schematic front view of the battery module 10 of the first embodiment attached to a base 2a of a battery case 2;

FIG. 6 is a partial perspective view of the battery module 10 of a second embodiment;

FIG. 7 is a partial perspective view of the battery module 10 of a third embodiment;

FIG. 8 is a cross-sectional view of a modification of the battery module 10 of the third embodiment taken along an intermediate plate 30C; and

FIG. 9 is a schematic front view of a battery module X in which a pair of end plates 40X are fixed to the base 2a.

### DESCRIPTION OF EMBODIMENTS

Hereinafter, battery modules of respective embodiments of the present disclosure will be described with reference to the drawings. The drawings shall be viewed in the direction of the symbols, in the description below, for ease of description, front, rear, left, right, upper and lower directions are set for convenience, and in the drawings, the front direction is indicated by Fr, the rear direction is indicated by Rr, the left direction is indicated by L, the right direction is indicated by R, the upper direction is indicated by U. and the lower direction is indicated by D.

### First Embodiment

First, a battery module 10 of a first embodiment of the present disclosure will be described.

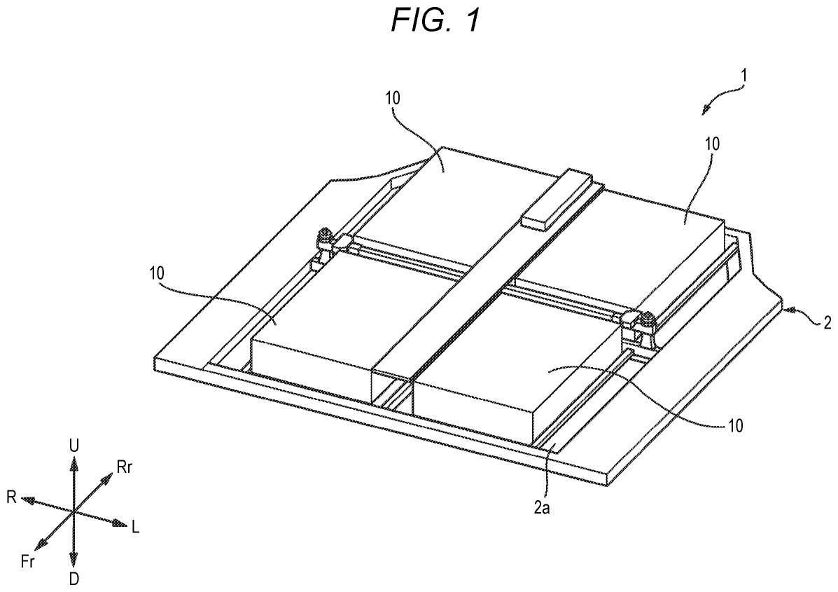

The battery module 10 is mounted on a vehicle (not shown), and is fixed to and supported by a base 2a of a battery case 2 as shown in FIG. 1. The base 2a is, for example, a frame member provided on the battery case 2 or a bottom wall of the battery case 2. A plurality of (here, four) battery modules 10 are supported by the base 2a, and the plurality of battery modules 10 are electrically connected to one another via electrical connection members (not shown). Further, electric power stored in the battery module 10 is supplied to, for example, a motor serving as a drive source of the vehicle. Here, the battery modules 10 and the battery case 2 constitute the battery pack 1.

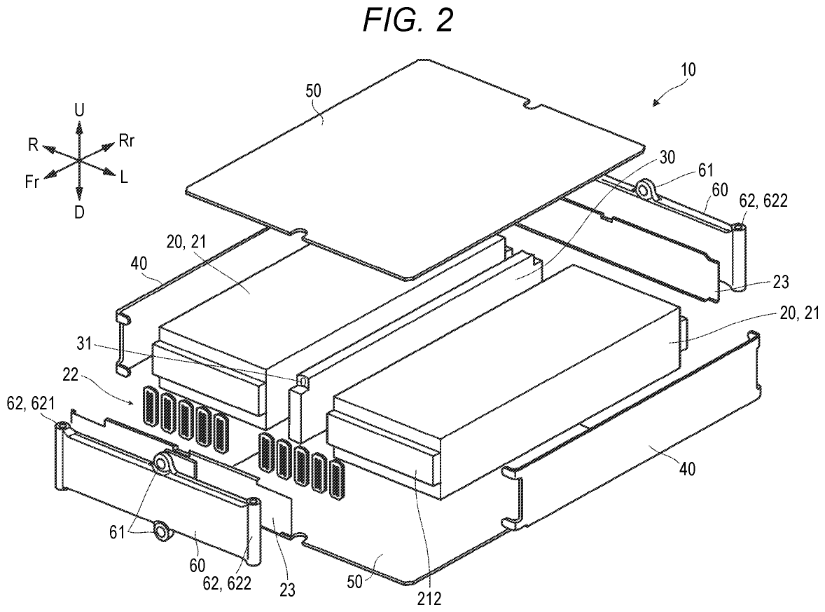

As shown in FIG. 2, the battery module 10 includes a cell laminate 20 in which a plurality of laminated cells 21 are laminated, an intermediate plate 30, a pair of end plates 40, a pair of restraining members 50, and cover plates 60.

The laminated cell 21 is, for example, a solid-state battery. As shown in FIG. 3, the laminated cell 21 implemented by a solid-state battery includes a positive electrode to which a positive electrode tab 21a is coupled, a negative electrode to which a negative electrode tab 21b is coupled, a solid electrolyte disposed between the positive electrode and the negative electrode, and a laminate film 21c for accommodating the solid electrolyte, and charge and discharge are performed by transferring lithium ions between the positive electrode and the negative electrode via the solid electrolyte. Further, a sealing portion 211 is provided on a periphery of the laminated cell 21. The positive electrode tab 21a extends from the sealing portion 211 on one-end side in a longitudinal direction of the laminated cell 21, and the negative electrode tab 21b extends from the sealing portion 211 on other-end side in the longitudinal direction of the laminated cell 21. Hereinafter, the positive electrode tab 21a and the negative electrode tab 21b are collectively referred to as an electrode tab 212.

The solid electrolyte is not particularly limited as long as having lithium ion conductivity and an insulating property, and materials generally used for all-solid-state lithium ion batteries can be used. Examples of the solid electrolyte include inorganic solid electrolytes such as sulfide solid electrolyte materials, oxide solid electrolyte materials, and lithium-containing salts; polymer-based solid electrolytes such as polyethylene oxide; and gel-based solid electrolytes containing lithium-containing salts and lithium-ion-conductive ionic liquids. A form of the solid electrolyte material is not particularly limited, and may be, for example, a particulate form.

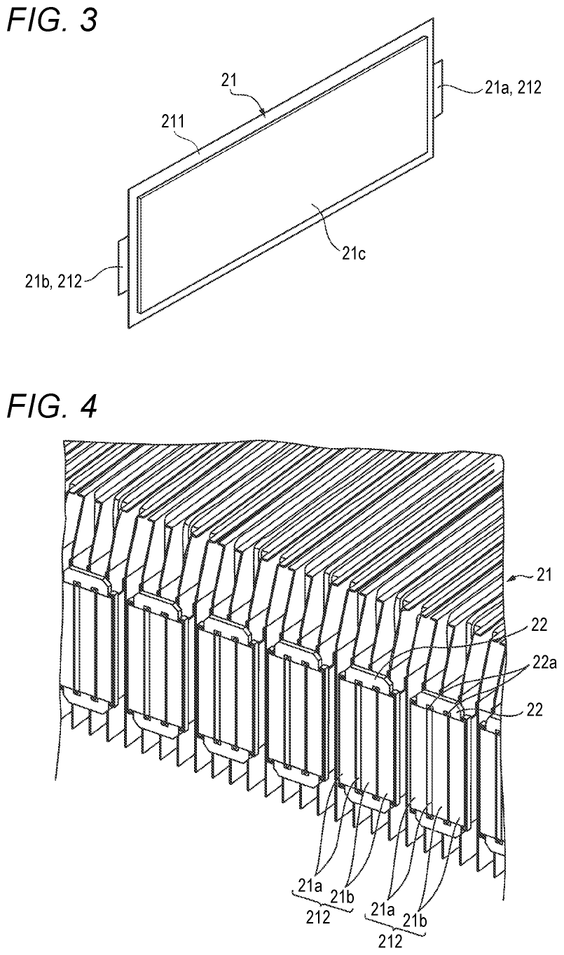

As shown in FIG. 4, the cell laminate 20 is configured by laminating a plurality of laminated cells 21 in the horizontal direction. In the present embodiment, each laminated cell 21 is disposed such that the electrode tab 212 extends in a front-rear direction. The laminated cells 21 are electrically connected via bus bars 22. Specifically, the laminated cells 21, 21 adjacent to each other are connected in parallel to each other via the bus bar 22, and other laminated cells 21, 21 further adjacent to each other are connected in parallel to each other via the bus bar 22. That is, the laminated cells 21, 21 connected in parallel and the laminated cells 21, 21 adjacent thereto are connected in series.

The bus bar 22 is a plate-shaped member and has two openings 22a. The tabs 21b, 21b, 21a, 21a are joined to the bus bar 22 in a state where the negative electrode tab 21b inserted through one of the openings 22a and the negative electrode tab 21b extending from one side of the bus bar 22 are bent at 90° from one side and are restrained, the positive electrode tab 21a inserted through the other opening 22a and the positive electrode tab 21a extending from the other side of the bus bar 22 are bent at 90° from the other side and are restrained, and the negative electrode tab 21b inserted through the one opening 22a and the positive electrode tab 21a inserted through the other opening 22a are overlapped. All of the plurality of laminated cells 21 constituting the battery module 10 may be connected in series, and the connection method is not limited.

Returning to FIG. 2, the intermediate plate 30 is provided at an intermediate portion in a lamination direction (here, a left-right direction) of the plurality of laminated cells 21. The intermediate plate 30 has substantially the same length as a length of the laminated cell 21 in the longitudinal direction (here, the front-rear direction) and a short-side direction (here, an upper-lower direction) of the laminated cell 21. Here, one intermediate plate 30 is provided at a central position in the lamination direction of the plurality of laminated cells 21, and divides the cell laminate 20 into two parts. The cell laminate 20 may be divided into three or more parts by providing two or more intermediate plates 30.

The pair of end plates 40 are provided on both end portions of the plurality of laminated cells 21 in the lamination direction. Each of the pair of end plates 40 has substantially the same length as the length of the laminated cell 21 in the longitudinal direction and the short-side direction of the laminated cell 21. Each laminated cell 21 swells due to aged deterioration or the like, and the cell laminate 20 swells in the lamination direction (hereinafter also referred to as cell swelling). The pair of end plates 40 receive a swelling force in the lamination direction due to the cell swelling.

The pair of restraining members 50 face each other in the upper-lower direction and are coupled to the pair of end plates 40 to restrain the plurality of laminated cells 21. Here, the pair of restraining members 50 each have a plate shape and cover the plurality of laminated cells 21, the intermediate plate 30, and the pair of end plates 40 in the upper-lower direction. The pair of restraining members 50 and the pair of end plates 40 are coupled by welding, for example. Here, the pair of restraining members 50 restrain the plurality of laminated cells 21, but does not prohibit dimensional expansion of the cell laminates 20 in the lamination direction caused by the cell swelling. The pair of restraining members 50 can extend in the lamination direction so as to allow dimensional expansion in the lamination direction to some extent.

The cover plate 60 is provided outward than the plurality of laminated cells 21 in the front-rear direction and extends in the lamination direction. Two cover plates 60 are provided to face each other in the front-rear direction. As viewed in the front-rear direction, the cover plate 60 covers the bus bars 22 and the electrode tabs 212 of the respective laminated cells 21 via a bus bar cover 23 having an electrical insulating property so as to protect the bus bars 22 and the electrode tabs 212.

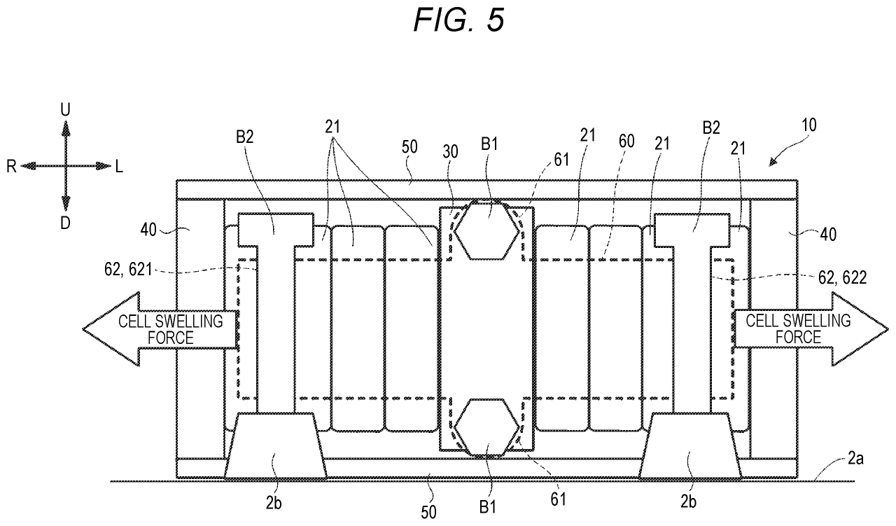

In the first embodiment, the cover plates 60 are coupled to the intermediate plate 30. Specifically, as shown in FIGS. 2 and 5, the cover plate 60 is provided with coupling portions 61 at a central position in the lamination direction. The coupling portion 61 is fastened to the intermediate plate 30 via a fastening member B1 such as a bolt. Specifically, the coupling portion 61 has a through hole through which the fastening member B1 is inserted in the front-rear direction, and the cover plate 60 is coupled to the intermediate plate 30 by screwing the fastening member B1 into a screw hole 31 provided in the intermediate plate 30.

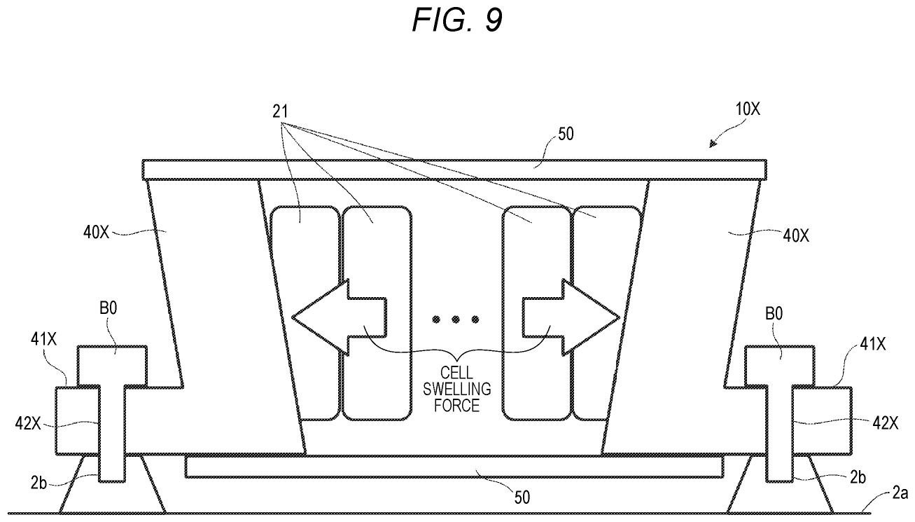

It is assumed that a pair of end plates 40X and the base 2a are fixed as shown in FIG. 9 when the battery module is fixed to the base 2a. More specifically, with reference to FIG. 9, a flange portion 41X extending in the lamination direction is provided at a lower end of each of the pair of end plates 40X, and a fixing portion 42X for fixing to the base 2a is provided at the flange portion 41X. The fixing portion 42X has a through hole through which a fastening member B0 such as a bolt is inserted, and a battery module 10X and the base 2a are fixed by screwing the fastening member B0 into a fixing portion 2b (here, a screw hole) provided in the base 2a.

In the configuration illustrated in FIG. 9, when the plurality of laminated cells 21 swell in the lamination direction, a large swelling force is applied to the pair of end plates 40X in the lamination direction since the pair of end plates 40X is fixed to the base 2a. Accordingly, stress concentrates particularly on the fixing portion 42X and the fixing portion 2b that are fixing portions between the battery module 10X and the base 2a. Further, since the fixing portions 42X are provided at the lower ends of the pair of end plates 40X, displacement in the lamination direction at upper ends of the pair of end plates 40X is allowed to some extent, but displacement in the lamination direction at the lower ends of the pair of end plates 40X is limited. Accordingly, a surface pressure applied to the pair of end plates 40X due to the cell swelling is biased in the upper-lower direction.

In the first embodiment, as shown in FIGS. 2 and 5, the cover plate 60 is provided with two fixing portions 62 (a first fixing portion 621 and a second fixing portion 622) that fix the battery module 10 to the base 2a on one-end side (a right side) and other-end side (a left side) with respect to the intermediate plate 30 in the lamination direction. The fixing portion 62 has a through hole through which a fastening member B2 such as a bolt can be inserted in the upper-lower direction, for example, and the through hole penetrates from an upper end to a lower end of the cover plate 60. The battery module 10 is fixed to the battery case 2 by inserting the fastening member B2 into the fixing portion 2b (screw hole) provided in the base 2a and the fixing portion 62 of the cover plate 60.

As described above, since the cover plate 60 is provided outward than the plurality of laminated cells 21 in the front-rear direction orthogonal to the lamination direction, concentration of stress on the fixing portion 62 due to the cell swelling can be prevented by providing the fixing portion 62 on the cover plate 60. Further, since concentration of stress on the fixing portion 62 due to the cell swelling can be prevented, for example, it is not necessary to separately provide a reinforcing structure in the vicinity of the fixing portion 62 (for example, to provide a reinforcing structure on the base 2a), and an increase in the number of components and an increase in size of the structure in relation to the structure of attaching the battery module 10 to the base 2a can be prevented.

Further, since the pair of end plates 40 are not provided with the fixing portions fixed to the base 2a, the surface pressure applied to the pair of end plates 40 due to the cell swelling is less biased in the upper-lower direction. Accordingly, the pair of end plates 40 and the pair of restraining members 50 can restrain the plurality of laminated cells 21 more uniformly.

Further, since the two fixing portions 62 (the first fixing portion 621 and the second fixing portion 622) are provided on both end portions of the cover plate 60 in the lamination direction, the battery module 10 can be stably fixed to the base 2a in the lamination direction.

### Second Embodiment

Next, the battery module 10 according to a second embodiment of the present disclosure will be described. The plurality of laminated cells 21 and the pair of restraining members 50 are common to those in the first embodiment, so that common reference numerals are given and description thereof is omitted.

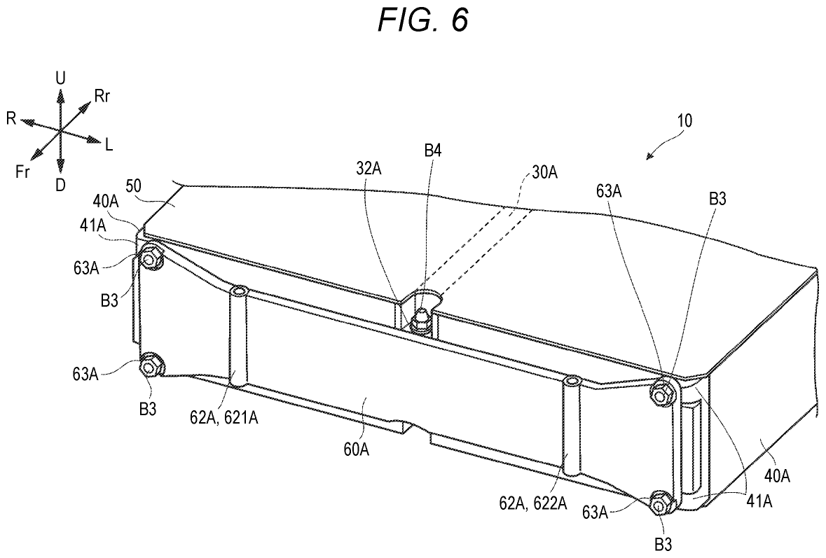

As shown in FIG. 6, the battery module 10 of the second embodiment includes an intermediate plate 30A, a pair of end plates 40A, and a cover plate 60A. The intermediate plate 30A, the pair of end plates 40A, and the cover plate 60A are disposed in the same manner as the intermediate plate 30, the pair of end plates 40, and the cover plate 60 of the first embodiment, so that a detailed description of these arrangements is omitted.

In the second embodiment, the cover plate 60A is also provided outward than the plurality of laminated cells 21 in the front-rear direction and extends in the lamination direction. Further, the cover plate 60A is provided with two fixing portions 62A (a first fixing portion 621A and a second fixing portion 622A), which fix the battery module 10 to the base 2a, on one-end side (a right side) and other-end side (a left side) with respect to the intermediate plate 30A in the lamination direction. With such a configuration, in the second embodiment, as in the first embodiment, concentration of stress on the fixing portion 62A due to cell swelling can also be prevented.

Unlike the cover plate 60 of the first embodiment, the cover plate 60A of the second embodiment is not coupled to the intermediate plate 30A, and is coupled to the pair of end plates 40A. Specifically, the cover plate 60A is provided with coupling portions 63A, which are coupled to the pair of end plates 40A, at both end positions in the lamination direction. The coupling portion 63A has a through hole through which a fastening member B3 such as a bolt can be inserted. Further, each of the pair of end plates 40A is provided with bent portions 41A extending in the lamination direction from both end portions in the front-rear direction. A screw hole (not shown) into which the fastening member B3 is screwed is formed in the bent portion 41A. The fastening member B3 is inserted into the through hole of the coupling portion 63A and the screw hole of the bent portion 41A, and the cover plate 60A is coupled to the pair of end plates 40A.

In the battery module 10 of the first embodiment, since the pair of end plates 40 and the cover plate 60 are not coupled to each other, the pair of end plates 40 may swing in the upper-lower direction around the intermediate plate 30 due to vibration of the vehicle. In the battery module 10 of the second embodiment, since the pair of end plates 40A and the cover plate 60A are coupled to each other, swinging of the pair of end plates 40A in the upper-lower direction due to vibration of the vehicle can be reduced.

The coupling portion 63A of the cover plate 60A is provided on one-end side (an upper side) and other-end side (a lower side) in the upper-lower direction. Accordingly, a surface pressure applied to the pair of end plates 40A due to the cell swelling is less biased in the upper-lower direction, and the plurality of laminated cells 21 can be more uniformly restrained.

In the second embodiment, the first fixing portion 621A and the second fixing portion 622A are respectively provided at a predetermined distance from the pair of end plates 40A in the lamination direction.

In the second embodiment, the intermediate plate 30A includes a fixing portion 32A fixed to the base 2a. In other words, the battery module 10 is fixed to the base 2a not only at the fixing portions 62A of the cover plate 60A but also at the fixing portion 32A of the intermediate plate 30A. The fixing portion 32A of the intermediate plate 30A has a through hole through which a fastening member B4 such as a bolt can be inserted in the upper-lower direction. The intermediate plate 30A and the base 2a are fixed by screwing the fastening member B4 inserted through the fixing portion 32A into a fixing portion (not shown) having a screw hole provided in the base 2a. Thus, by providing the fixing portion 32A on the intermediate plate 30A, the battery module 10 can be more stably fixed to the base 2a.

Diameters of the through holes provided in the first fixing portion 621A and the second fixing portion 622A of the cover plate 60A are both smaller than a diameter of the through hole provided in the fixing portion 32A of the intermediate plate 30A. Thus, by reducing the diameters of the through holes provided in the first fixing portion 621A and the second fixing portion 622A of the cover plate 60A, an increase in a thickness (that is, a length in the front-rear direction) of the cover plate 60A can be prevented. Accordingly, dimensions of the plurality of laminated cells 21 in the longitudinal direction (the front-rear direction) can be increased, and the energy density of the entire battery module 10 can be increased.

### Third Embodiment

Next, the battery module 10 according to a third embodiment of the present disclosure will be described. The plurality of laminated cells 21 and the pair of restraining members 50 are common to those in the first embodiment, so that common reference numerals are given and description thereof is omitted.

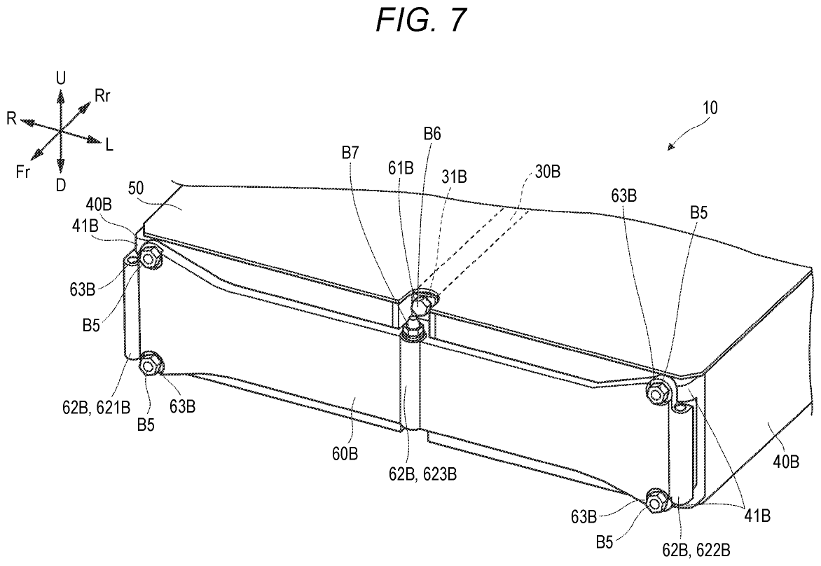

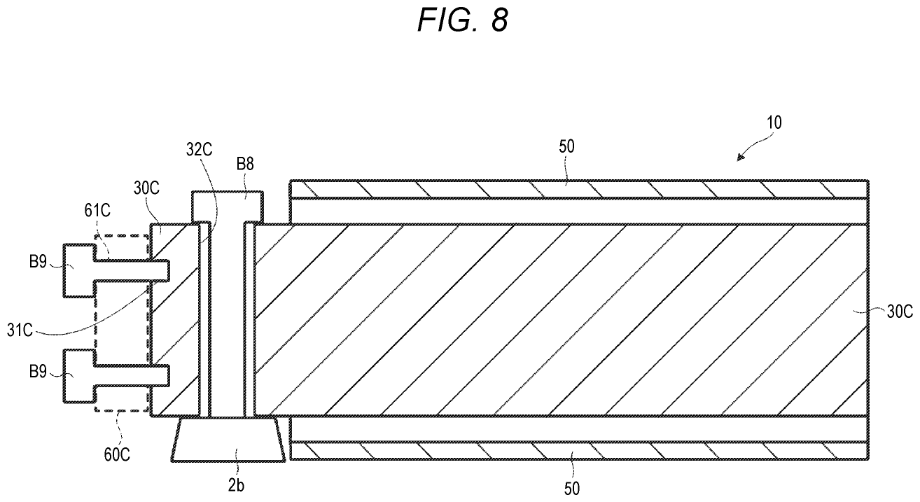

As shown in FIG. 7, the battery module 10 of the third embodiment includes an intermediate plate 30B, a pair of end plates 40B, and a cover plate 60B. Here, the intermediate plate 30B has the same configuration as the intermediate plate 30 of the first embodiment. The pair of end plates 40B have the same configuration as the pair of end plates 40A of the second embodiment, and each includes bent portions 41B corresponding to the bent portions 41A. The intermediate plate 30B, the pair of end plates 40B, and the cover plate 60B are disposed in the same manner as the intermediate plate 30, the pair of end plates 40, and the cover plate 60 of the first embodiment, so that a detailed description of these arrangements is omitted.

In the third embodiment, the cover plate 60B is also provided outward than the plurality of laminated cells 21 in the front-rear direction and extends in the lamination direction. Further, the cover plate 60B is provided with two fixing portions 62B (a first fixing portion 621B and a second fixing portion 622B), which fix the battery module 10 to the base 2a, on one-end side (a right side) and other-end side (a left side) with respect to the intermediate plate 30B in the lamination direction. With such a configuration, in the third embodiment, as in the first embodiment and the second embodiment, concentration of stress on the fixing portion 62B due to cell swelling can also be prevented.

The cover plate 60B of the third embodiment is coupled to both the intermediate plate 30B and the pair of end plates 40B. Specifically, the cover plate 60B is provided with coupling portions 63B, which are coupled to the pair of end plates 40B, at positions corresponding to the bent portions 41B of the pair of end plates 40B in the lamination direction. Since the configuration of the coupling portion 63B is the same as the configuration of the coupling portion 63A, a description thereof is omitted. A fastening member B5 is inserted into a through hole of the coupling portion 63B of the cover plate 60B and a screw hole of the bent portion 41B, and the cover plate 60B is coupled to the pair of end plates 40B. Further, the cover plate 60B is provided with a coupling portion 61B at a position of a screw hole 31B (corresponding to the screw hole 31 of the intermediate plate 30) provided in the intermediate plate 30B. The coupling portion 61B is erected from an upper end of the cover plate 60B at a central position of the cover plate 60B in the lamination direction, and has a through hole through which a fastening member B6 is inserted in the front-rear direction. By screwing the fastening member B6 into the screw hole 31B of the intermediate plate 30B, the cover plate 60B is coupled to the intermediate plate 30B.

Thus, since the cover plate 60B is coupled to both the intermediate plate 30B and the pair of end plates 40B, the rigidity of the entire battery module 10 is improved.

As described above, since the cover plate 60B is coupled to the pair of end plates 40B, swinging of the pair of end plates 40B around the intermediate plate 30B in the upper-lower direction due to vibration of the vehicle can be reduced, similar to the battery module of the second embodiment. Here, moments with the first fixing portion 621B and the second fixing portion 622B as fulcrums are applied to the coupling portions 63B of the cover plate 60B and the bent portions 41B of the pair of end plates 40B when the swinging of the pair of end plates 40B is reduced.

In the third embodiment, unlike the second embodiment, the first fixing portion 621B and the second fixing portion 622B are provided at positions overlapping the pair of end plates 40B as viewed in the front-rear direction. As compared with the second embodiment, since distances from the first fixing portion 621B and the second fixing portion 622B to the coupling portion 63B and the bent portions 41B are short, the moments applied to the coupling portion 63B and the bent portions 41B with the first fixing portion 621B and the second fixing portion 622B as fulcrums can be reduced. Further, since the first fixing portion 621B and the second fixing portion 622B are provided at positions not overlapping the plurality of laminated cells 21 as viewed in the front-rear direction, dimensions of the plurality of laminated cells 21 in the longitudinal direction can be increased, and the energy density of the entire battery module 10 can be increased.

In the third embodiment, the fixing portion 62B of the cover plate 60B includes a third fixing portion 623B provided between the first fixing portion 621B and the second fixing portion 622B as viewed in the front-rear direction. The third fixing portion 623B has a through hole through which a fastening member B7 such as a bolt can be inserted in the upper-lower direction. The cover plate 60B and the base 2a are fixed by screwing the fastening member B7 inserted through the third fixing portion 623B into a fixing portion (not shown) having a screw hole provided in the base 2a. Thus, by providing the third fixing portion 623B in addition to the first fixing portion 621B and the second fixing portion 622B, the battery module 10 can be more stably fixed to the base 2a.

When describing the fixing portion 62B in more detail, the third fixing portion 623B is provided at a position overlapping the intermediate plate 30B as viewed in the front-rear direction. Further, diameters of the through holes provided in the first fixing portion 621B and the second fixing portion 622B are both smaller than a diameter of the through hole provided in the third fixing portion 623B. Thus, by reducing the diameters of the through holes provided in the first fixing portion 621B and the second fixing portion 622B of the cover plate 60B, an increase in a thickness (that is, a length in the front-rear direction) of the cover plate 60B can be prevented. Accordingly, dimensions of the plurality of laminated cells 21 in the longitudinal direction (the front-rear direction) can be increased, and the energy density of the entire battery module 10 can be increased.

### (Modification)

Next, a modification of the battery module 10 of the third embodiment will be described.

In the battery module 10 of the modification, instead of providing the third fixing portion 623B on the cover plate 60B of the third embodiment, a fixing portion 32C is provided on an intermediate plate 30C as shown in FIG. 8. The fixing portion 32C of the intermediate plate 30C has a through hole through which a fastening member B8 such as a bolt can be inserted in the upper-lower direction. The intermediate plate 30C and the base 2a are fixed by screwing the fastening member B8 inserted through the fixing portion 32C into the fixing portion 2b having a screw hole provided in the base 2a. Thus, by providing the fixing portion 32C on the intermediate plate 30C, the battery module 10 can also be more stably fixed to the base 2a.

In the present modification, the cover plate 60C is provided with a coupling portion 61C coupled to the intermediate plate 30C, instead of the coupling portion 61B of the cover plate 60B of the third embodiment. The coupling portion 61C has through holes through which fastening members B9 are respectively inserted in the front-rear direction. The cover plate 60C is coupled to the intermediate plate 30C by screwing the fastening members B9 into screw holes 31C provided in a front surface of the intermediate plate 30C.

Although various embodiments have been described above with reference to the drawings, it is needless to say that the present invention is not limited to these examples. It is apparent that those skilled in the art can conceive of various modifications and changes within the scope described in the claims, and it is understood that such modifications and changes naturally fall within the technical scope of the present invention. In addition, respective constituent elements in the above-described embodiments may be freely combined without departing from the gist of the invention.

For example, in each of the embodiments described above, the battery module 10 is attached to the base 2a of the battery case 2, but the present invention is not limited thereto, and any member that supports the battery module 10 may be used. For example, the battery module 10 may be attached to a vehicle body frame.

Further, in each of the embodiments described above, two cover plates 60, 60A, 60B, or 60C are provided so as to face each other in the front-rear direction, but the present invention is not limited thereto. A configuration in which the cover plate 60, 60A, 60B, or 60C is provided only on either one of a front side and a rear side may be employed.

In each of the exemplary embodiments described above, the pair of restraining members 50 each have a plate shape, but the present invention is not limited thereto. The pair of restraining members 50 each may have, for example, a band shape as long as being able to restrain the plurality of laminated cells 21. Further, the coupling between the pair of restraining members 50 and between the pair of end plates 40 is not limited to welding, and may be performed using fastening members such as bolts.

In the first embodiment described above, the cover plate 60 is provided with the first fixing portion 621 and the second fixing portion 622, but a third fixing portion may be further provided between the first fixing portion 621 and the second fixing portion 622. Accordingly, the battery module 10 can be more stably fixed to the base 2a.

In the second embodiment described above, the first fixing portion 621A and the second fixing portion 622A are each provided at a predetermined distance from the pair of end plates 40A in the lamination direction, but the present invention is not limited thereto. For example, the first fixing portion 621A and the second fixing portion 622A may be provided at positions overlapping the pair of end plates 40A as viewed in the front-rear direction, as the first fixing portion 621B and the second fixing portion 622B of the third embodiment.

In the present description, at least the following matters are described. Although corresponding constituent elements or the like in the above-described embodiments are shown in parentheses, the present invention is not limited thereto.
(1) A battery module (battery module 10) to be mounted on a vehicle and fixed to a support member (base 2a), the battery module having:
a plurality of laminated cells (plurality of laminated cells 21) laminated in a horizontal direction;
an intermediate plate (intermediate plate 30, 30A, 30B, 30C) provided in an intermediate portion in a lamination direction (left-right direction) of the plurality of laminated cells;
a pair of end plates (pair of end plates 40, 40A, 40B) provided on both end portions of the plurality of laminated cells in the lamination direction; and
a pair of restraining members (restraining members 50) facing each other in a first direction (upper-lower direction) orthogonal to the lamination direction and coupled to the pair of end plates to restrain the plurality of laminated cells,
in which each of the laminated cells includes an electrode tab (electrode tab 212) extending in a second direction (front-rear direction) orthogonal to the lamination direction and the first direction,
a cover plate (cover plate 60, 60A, 60B, 60C) extending in the lamination direction and covering the electrode tab is provided outward than the plurality of laminated cells in the second direction,
the cover plate is coupled to at least one of the intermediate plate or the pair of end plates, and
the cover plate is provided with at least a first fixing portion (first fixing portion 621, 621A, 621B) and a second fixing portion (second fixing portion 622, 622A, 622B), which fix the battery module to the support member, on one-end side and other-end side in the lamination direction with respect to the intermediate plate.

According to the above (1), the battery module is provided with the cover plate that covers the electrode tab, in addition to the end plates and the restraining members. Further, the cover plate is provided with at least the first fixing portion and the second fixing portion for fixing the battery module to the support member. Since the cover plate is provided outward than the plurality of laminated cells in the second direction orthogonal to the lamination direction, concentration of stress on the fixing portion between the battery module and the support member due to cell swelling can be prevented.
(2) The battery module according to the above (1),
in which the cover plate is coupled to at least the pair of end plates.

According to the above (2), since the pair of end plates and the cover plate are coupled to each other, swinging of the pair of end plates in the first direction due to vibration of the vehicle can be reduced.
(3) The battery module according to the above (2),
in which coupling portions (coupling portion 63A, 63B) between the cover plate and each of the end plates are provided on at least one-end side and other-end side in the first direction.

According to the above (3), a surface pressure applied to the pair of end plates due to the cell swelling is less biased in the first direction. Thus, the plurality of laminated cells can be more uniformly restrained.
(4) The battery module according to the above (1),
in which the intermediate plate includes a fixing portion (fixing portion 32A, 32C) fixed to the support member.

According to the above (4), since the fixing portion fixed to the support member is also provided on the intermediate plate, in addition to the first fixing portion and the second fixing portion of the cover plate, the battery module can be more stably fixed to the support member.
(5) The battery module according to the above (1),
in which the cover plate is coupled to at least the intermediate plate, and the intermediate plate includes a fixing portion (fixing portion 32A, 32C) fixed to the support member.

According to the above (5), since the cover plate is coupled to the intermediate plate and the fixing portion fixed to the support member is also provided on the intermediate plate, in addition to the first fixing portion and the second fixing portion of the cover plate, the battery module can be more stably fixed to the support member.
(6) The battery module according to the above (4) or (5),
in which the first fixing portion and the second fixing portion of the cover plate and the fixing portion of the intermediate plate each have a hole through which a fastening member is insertable in the first direction, and
a diameter of the through hole provided in each of the first fixing portion and the second fixing portion of the cover plate is smaller than a diameter of the through hole provided in the fixing portion of the intermediate plate.

According to the above (6), since the diameter of the through hole provided in each of the first fixing portion and the second fixing portion of the cover plate is smaller than the diameter of the through hole provided in the fixing portion of the intermediate plate, an increase in a thickness of the cover plate can be prevented. Accordingly, dimensions of the plurality of laminated cells in the second direction can be increased, and the energy density of the entire battery module can be increased.
(7) The battery module according to any one of the above (1) to (4),
in which the cover plate is coupled to at least the intermediate plate, and
the cover plate further includes a third fixing portion (third fixing portion 623B) provided between the first fixing portion and the second fixing portion.

According to the above (7), since the cover plate includes the third fixing portion in addition to the first fixing portion and the second fixing portion, the battery module can be more stably fixed to the support member.
(8) The battery module according to the above (7),
in which the third fixing portion is provided at a position overlapping the intermediate plate as viewed in the second direction,
the first fixing portion, the second fixing portion, and the third fixing portion of the cover plate each have a through hole through which a fastening member is insertable in the first direction, and
a diameter of the through hole provided in each of the first fixing portion and the second fixing portion is smaller than a diameter of the through hole provided in the third fixing portion.

According to the above (8), since the diameter of the through hole provided in each of the first fixing portion and the second fixing portion is smaller than the diameter of the through hole provided in the third fixing portion provided at a position overlapping the intermediate plate, an increase in the thickness of the cover plate can be prevented. Accordingly, dimensions of the plurality of laminated cells in the second direction can be increased, and the energy density of the entire battery module can be increased.
(9) The battery module according to the above (2) or (3),
in which the first fixing portion and the second fixing portion of the cover plate are provided respectively at positions overlapping the pair of end plates as viewed in the second direction.

According to the above (9), since the first fixing portion and the second fixing portion are disposed in the vicinity of the coupling portions between the pair of end plates and the cover plate, moments applied to the coupling portions with the first fixing portion and the second fixing portion as fulcrums can be reduced.

What is claimed is:

1. A battery module to be mounted on a vehicle and fixed to a support member, the battery module comprising:
a plurality of laminated cells laminated in a horizontal direction;
an intermediate plate provided in an intermediate portion in a lamination direction of the plurality of laminated cells;
a pair of end plates provided on both end portions of the plurality of laminated cells in the lamination direction; and
a pair of restraining members facing each other in a first direction orthogonal to the lamination direction and coupled to the pair of end plates to restrain the plurality of laminated cells,
wherein each of the laminated cells includes an electrode tab extending in a second direction orthogonal to the lamination direction and the first direction,
a cover plate extending in the lamination direction and covering the electrode tab is provided outward than the plurality of laminated cells in the second direction,
the cover plate is coupled to at least one of the intermediate plate or the pair of end plates, and
the cover plate is provided with at least a first fixing portion and a second fixing portion, which fix the battery module to the support member, on one-end side and other-end side in the lamination direction with respect to the intermediate plate.

2. The battery module according to claim 1,
wherein the cover plate is coupled to at least the pair of end plates.

3. The battery module according to claim 2,
wherein coupling portions between the cover plate and each of the end plates are provided on at least one-end side and other-end side in the first direction.

4. The battery module according to claim 1,
wherein the intermediate plate includes a fixing portion fixed to the support member.

5. The battery module according to claim 1,
wherein the cover plate is coupled to at least the intermediate plate, and
the intermediate plate includes a fixing portion fixed to the support member.

6. The battery module according to claim 4,
wherein the first fixing portion and the second fixing portion of the cover plate and the fixing portion of the intermediate plate each have a through hole through which a fastening member is insertable in the first direction, and
a diameter of the through hole provided in each of the first fixing portion and the second fixing portion is smaller than a diameter of the through hole provided in the fixing portion of the intermediate plate.

7. The battery module according to claim 5,
wherein the first fixing portion and the second fixing portion of the cover plate and the fixing portion of the intermediate plate each have a through hole through which a fastening member is insertable in the first direction, and
a diameter of the through hole provided in each of the first fixing portion and the second fixing portion is smaller than a diameter of the through hole provided in the fixing portion of the intermediate plate.

8. The battery module according to claim 1,
wherein the cover plate is coupled to at least the intermediate plate, and
the cover plate further includes a third fixing portion provided between the first fixing portion and the second fixing portion.

9. The battery module according to claim 8,
wherein the third fixing portion is provided at a position overlapping the intermediate plate as viewed in the second direction,
the first fixing portion, the second fixing portion, and the third fixing portion of the cover plate each have a through hole through which a fastening member is insertable in the first direction, and
a diameter of the through hole provided in each of the first fixing portion and the second fixing portion is smaller than a diameter of the through hole provided in the third fixing portion.

10. The battery module according to claim 2,
wherein the first fixing portion and the second fixing portion of the cover plate are provided respectively at positions overlapping the pair of end plates as viewed in the second direction.
